(19) United States
(12) Patent Application Publication
(10) Pub. No.: US 2012/0152167 A1
(43) Pub. Date: Jun. 21, 2012

(54) Wallpaper Border Sizing Sealant Applicator Tool & Paint Trim Guide

(76) Inventor: Louis P. Smoter, Clinton Township, MI (US)

(21) Appl. No.: 12/971,104

(22) Filed: Dec. 17, 2010

(51) Int. Cl. B05C 17/06

(52) U.S. Cl. 118/712

(57) ABSTRACT

A wallpaper border sealant applicator tool includes a cross-beam member having slide block members attached to each end thereof with a through opening in each slide block member. A column member is mounted in each of the through openings for sliding engagement of the cross-beam member with respect to the column members. Each end of a guide bar member is attached to the column members such that a wallpaper border width can be set between the cross-beam member and the guide bar member to provide a tool for applying sealant to the wall for the subsequent attachment of a wallpaper border.

### CROSS-REFERENCE TO RELATED APPLICATIONS

Not applicable.

### STATEMENT REGARDING FEDERALLY SPONSORED RESEARCH

Not applicable.

### REFERENCE TO SEQUENCE LISTING

Not applicable.

### BACKGROUND OF THE INVENTION

1. Field of the Invention

This invention relates to an apparatus useful in painting and wallpaper border applications; and more specifically, to a tool for applying paint around trim work and moldings, and a measuring guide for applying a sizing sealer for the application of a wallpaper border.

2. Description of Related Art

Mechanical cutters or markers, known for many decades, are designed to facilitate the speed with which users cut or mark various materials as well as to aid in determining particular widths, depths, or other dimensions of cutting or marking. Most of these implements are normally designed to slide along an edge of a board or the like and have a holder for a blade or marking tool. In most cases, these devices also include means for adjusting the cutting widths. Regarding the art of specifically cutting wallpaper and devices for paper hanging, in general, the art is typified by U.S. Pat. No. 2,044,426 issued to Arthur Gelleff for a device for cutting or trimming wallpaper; U.S. Pat. No. 4,077,124 issued to Norbert Christmann for a hand-tool guide to cut wallpaper neatly and simply; U.S. Pat. No. 4,501,069 issued to Seiji Kohno for cutting uniform vertical edges on wallpaper; and U.S. Pat. No. 4,868,989 issued to Fredric Renaud for a wallpaper border marking/cutting device which simultaneously travels along a wall and a ceiling with an adjustable blade which has the option of inserting a marking instrument that may be adjusted to a selected distance from the ceiling and which is held in place for smooth parallel marking or cutting so as to enable a user to rapidly glide across a wall or hang wallpaper to mark the wall or cut and remove the top portion of wallpaper to create an even edge for abutment with a separately hung wallpaper border which will meet flush with the wallpaper in the same plane.

In order to complete the wallpaper border application process after the border has been marked or cut to proper height, it is necessary to apply a border which may be accomplished in one of two different procedures. Sizing sealant (liquid adhesive) may be applied to the border area followed by the manual application of a wallpaper border which is available in the form of a roll. Since the lower portion of the wall has already been wallpapered, the sizing sealant application becomes very time consuming to insure that the sizing adhesive does not drip or run onto the freshly applied wallpaper. The prior art has proposed several border applicators to avoid the problem of soiling the freshly applied wallpaper with the sizing adhesive for the border wallpaper. For example, Araujo, U.S. Pat. No. 5,403,430, proposes a spool disposed at one end of a tray within the sidewalls for dispensing a roll of wallpaper border, a roller at another end of the tray for applying the wallpaper border to the wall, and a wiper blade between the spool and the roller for wiping excess paste and water from the border. The excess paste and water collect in the tray. Edney et al., U.S. Pat. No. 5,573,630 discloses an applicator mounted on a shaft and having a reservoir. The wallpaper border is wrapped around a tubular portion of the spindle. The back face of the wallpaper border has a dry adhesive which is activated by water. The roll is soaked in water. A plurality of openings between upper and lower surfaces of the flange portion of the spindle allows excess water or paste to drip from the roll into the reservoir defined by a cup-shaped member.

Renaud, U.S. Pat. No. 5,628,867, discloses a device which automatically redirects an unwinding roll of paper border in a transverse direction for horizontal application onto a wall. A liquid paste container is controlled by a flow regulator for controlling the dispensing of liquid paste from the container. A contact guide attaches the container against rectangular cutouts to assure contact pressure between an advancing paper border and the rectangular cutouts and seal off the rectangular cutouts that extend beyond the width of the paper border.

While the foregoing prior art discloses various devices for applying wallpaper border to walls, it does not teach a wallpaper border marking device for the application of the sizing adhesive sealant which is simple, economical, easy to use as well as which provides the following features. The applicator has a ruler surface so that measurements of distance can be readily measured to accommodate different widths of wallpaper border; prevents water from running down walls and running down the arms of a person applying the wallpaper border to the wall; is readily adapted for use by either right-handed or left-handed individuals; is used for installing horizontally oriented strips of wallpaper border; provides for border wallpaper installation both in vertical or horizontal orientation; is readily adapted to be used for applying wallpaper border in either right-to-left or left-to-right direction; and provides a separate paint trim edge that provides many of the same advantageous features.

Accordingly, what is needed is a simple, economical, easy to use tool for guiding the application of a sizing sealant onto a wall for the subsequent addition of a wallpaper border.

### SUMMARY OF THE INVENTION

The present invention is a lightweight, handheld frame apparatus intended to be used for the application of a sizing sealer for a wallpaper border application. The apparatus further includes an edging tool for applying paint around trim work and moldings. The apparatus includes spaced-apart, equal length, upright column members with a transversely oriented sliding cross-beam member therebetween. Each end of the transverse cross-beam member includes a slide block attached to the cross-beam member. Alternatively, the transverse cross-beam member and slide blocks may be molded as a unitary part. The slide block has a through opening for receiving a respective column member of the spaced-apart upright column members. The fit between the through openings in the slide block and each respective column member is a sliding fit such that the slide blocks at each end of the cross-beam member can conveniently slide along each column member from one end to the opposite end thereof. To facilitate control of the sliding movement of the cross-beam member and slide blocks along the column members, a finger grip bar is attached to one side of the transversely oriented cross-beam member (preferably the side facing the user). The finger grip bar is attached to the cross-beam member with appropriate spacers between the finger grip bar and the cross-beam bar. Any type of convenient fastener including adhesives may be used to mount the finger grip bar and spacers to the cross-beam bar.

Mounted to the top end of each of the upright column member is a knife edge metal guide bar which is adapted to be used as a measurement gauge when the tool is used to measure the width of the wallpaper border to be applied to the wall and further as a trim edge when the apparatus is used to paint door trim, window trim, and assorted wall moldings.

The front edge of the column members have measurement indicia printed thereon. This indicia is facing the holder so that when the width of the wallpaper border is known, the same width is set on the frame apparatus by loosening the wing screws on the slide blocks and adjusting the slide blocks to the same width as the known wallpaper border width. Both slide blocks are locked in place at the known width setting so that the area between the top of the cross-beam member and the knife edge metal guide bar is the area where the sizing sealer is applied to the wall to accommodate the known wallpaper border.

One further feature of the apparatus is that the rear facing side of the sliding cross-beam member that interfaces with the wall upon which the wallpaper border will be applied has a shoulder or undercut in which is mounted a resilient strip material to collect any sizing sealer that may want to drain down the wall. The strip material will prevent any overflow sealer from traveling down the wall onto freshly applied wallpaper or newly applied paint.

It is therefore an object of the present invention to provide a new tool for applying sizing sealant to a wall, to which a wallpaper border is to be applied, which is of simple construction and reliable to use.

It is another object of the present invention to provide a new and improved sizing sealant applicator apparatus for applying a wallpaper border which prevents water from running down walls and running down the arms of a person applying the wallpaper border to the walls.

It is a further object of the present invention to provide a new and improved sizing sealant applicator apparatus for applying a wallpaper border which provides for installation of wallpaper border both in a vertical and horizontal orientation.

Yet another object of the present invention is to provide a new and improved sizing sealant applicator apparatus for applying a wallpaper border which is readily adapted for use by either right-handed or left-handed persons.

Still another object of the present invention is to provide a new and improved sizing sealant applicator apparatus for applying a wallpaper border which is readily adapted to be used for applying sizing sealant in either right-to-left or left-to-right direction.

Yet another object of the present invention is to provide a new and improved sizing sealant applicator apparatus for applying a wallpaper border that has a ruler surface so that measurements of the distance can be readily measured.

It is still a further object of the present invention to provide a new and improved sizing sealant applicator apparatus for applying a wallpaper border which is easy to use, economical to purchase, and simple to manufacture.

Another object of the present invention is to provide a new and improved sizing sealant applicator measuring apparatus for applying a wallpaper border which, in addition, provides an edging tool for applying paint around trim work and moldings.

These and other features and advantages of this invention are described in, or apparent from, the following detailed description of exemplary embodiments in the detailed description, the drawings, and the appended claims.

### BRIEF DESCRIPTION OF THE DRAWINGS

The invention will be better understood and become more apparent by reference to the following description of the embodiments of the invention taken in conjunction with the accompanying drawings wherein:

FIG. 1 is a perspective view of the wallpaper border sizing sealant applicator apparatus for the application of a wallpaper border above a chair rail molding according to an embodiment of the invention;

FIG. 2 is a plan view of the wallpaper border sizing sealant applicator tool and paint trim guide apparatus according to an embodiment of the invention;

FIG. 3 is a side view of the wallpaper border sizing sealant applicator tool and paint trim guide apparatus according to an embodiment of the invention;

FIG. 4 is a bottom view of the wallpaper border sizing sealant applicator tool and paint trim guide apparatus according to an embodiment of the invention;

FIG. 5 is a partial cross-section view along lines A-A of FIG. 3;

FIG. 6 is a cross-section view along lines B-B of the cross-beam member shown in FIG. 2; and

FIG. 7 is a perspective view of another feature of the applicator tool of the invention wherein the metal guide bar serves as a paint trim tool.

### DETAILED DESCRIPTION OF THE PREFERRED EMBODIMENT

With reference to the drawings, a new and improved sizing sealer measuring apparatus to apply a wallpaper border embodying the principles and concepts of the present invention will be described.

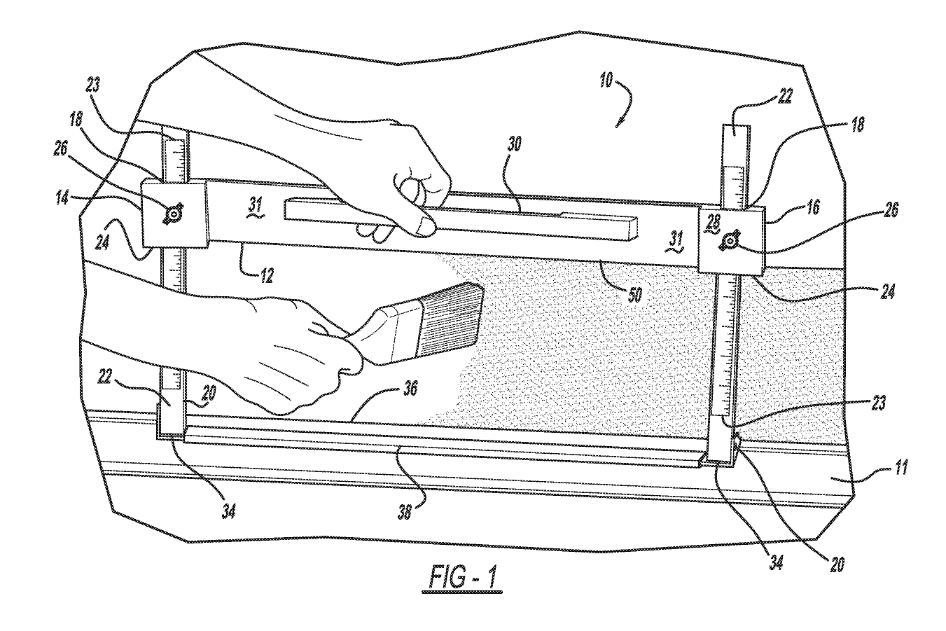

Turning to FIGS. 1-7, there is shown an exemplary embodiment of the wallpaper border sizing sealant applicator and measuring apparatus 10 of the invention for applying a border above a chair rail molding 11 of a room. To visualize a ceiling border application, FIG. 1 should be rotated 180° which illustrates a border application for a ceiling border. The figures illustrate a horizontal cross-beam member 12 having slide blocks 14, 16 attached at respective ends of the horizontal cross-beam member 12. Alternatively, the slide blocks 14, 16 and horizontal cross-beam member 12 may be molded as a single member. A through opening 18 in each slide block 14, 16 is adapted to receive a column member 20. Each column member 20 resides in the through opening 18 and has a sliding fit therewith such that the horizontal cross-beam member 12 can conveniently slide up and down the column member 20. The column members 20 as shown in the figures are rectangular in cross-section. However, it is understood that the cross-section of the column members 20 could be square, round, elliptical, or any other configuration providing that the through opening 18 of the horizontal cross-beam member 12 is complimentary in cross-section so that the horizontal cross-beam member 12 can easily slide along each column member 20 from one end to the opposite end thereof.

The front face 22 of each of the column members 20 is provided with indicia in the form of a graduated scale or ruler. Alternatively, a metal ruler 23 may be mounted in a recessed slot 24 on the front face 22 of each of the column members 20. The metal ruler 23 is used to set the horizontal cross-beam member 12 at the width of the wallpaper border to be applied to the wall. For example, if an eight inch border is to be applied to the wall, the horizontal cross-beam member 12 is slid along the column members 20 so that the top surface 24 on each slide block 14, 16 aligns with the eight inch line of each metal ruler 23 of the column member 20. A wing screw 26 is mounted through the front face 28 of each slide block 14, 16 to lock the horizontal cross-beam member 12 to the column members 20 after the correct border width has been set. A blunt nose (not shown) on the front end of the wing screw 26 bears on the ruler surface to lock the horizontal cross-beam member 12 to the column member 20.

To facilitate easy manipulation of the sliding movement of the horizontal cross-beam member 12 and slide blocks 14, 16, along the column members 20, a finger grip bar 30 is attached to the front face 31 of the transversely oriented cross-beam member 12 (preferably the side facing the user). The finger grip bar 30 is mounted to the horizontal cross-beam member 12 with appropriate spacers or riser blocks (not shown) if required between the finger grip bar 30 and the horizontal cross-beam member 12. The attachment member can be a screw at opposing ends of the finger grip bar 30 or alternatively an adhesive can be used to attach the finger grip bar 30 to the riser blocks which in turn is adhesively attached to the horizontal cross-beam member 12.

Mounted to the top end 34 of each of the column members 20 is a metal guide bar 36 that is attached to the two column members 20. The purpose of this metal guide bar 36 is two-fold. First, in order to provide a straight edge for purposes of setting the width of the wallpaper border, the metal guide bar 36 has a snap-on metal reinforcement member 38 mounted thereon. The reinforcement metal guide bar 38 is mounted piggyback to the metal guide bar 36 to provide a sturdy straight edge from which measurements of the border width can be made so as to set the horizontal cross-beam member 12 to the correct border width when applying the sizing sealant to the wall. Second, the metal guide bar 36 as shown in FIG. 5, has a knife edge 40 along one end thereof which is used as an edging tool for applying paint around trim work and moldings as hereinafter disclosed. Note that the reinforcement metal guide bar 38 only covers approximately one-half of the total width of the metal guide bar 36. The remainder of the metal guide bar 36 extends well beyond the edge of the reinforcement metal guide bar 38 as well as the edge of the column members 20. The extended portion is a knife edge 40 and extends beyond the rear face 41 of the column member 20 to line up with the rear face 43 of the slide blocks 14, 16. To insure that when the wallpaper border sizing sealant applicator measuring apparatus 10 is placed against the wall it will be in a perfectly vertical upright position. The knife edge 40 of the metal guide bar 36 and the rear face 43 of the slide blocks 14, 16 create contact with the wall.

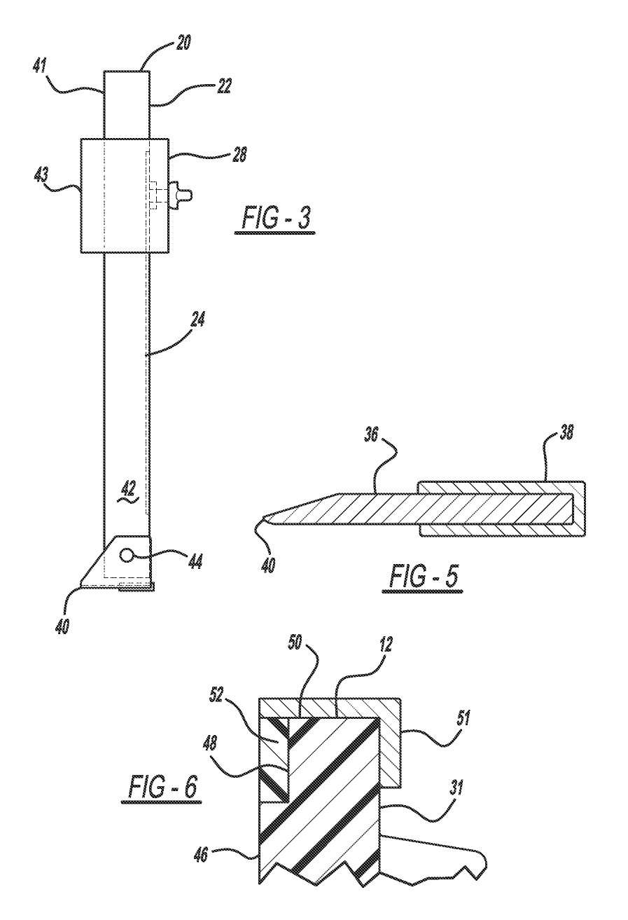

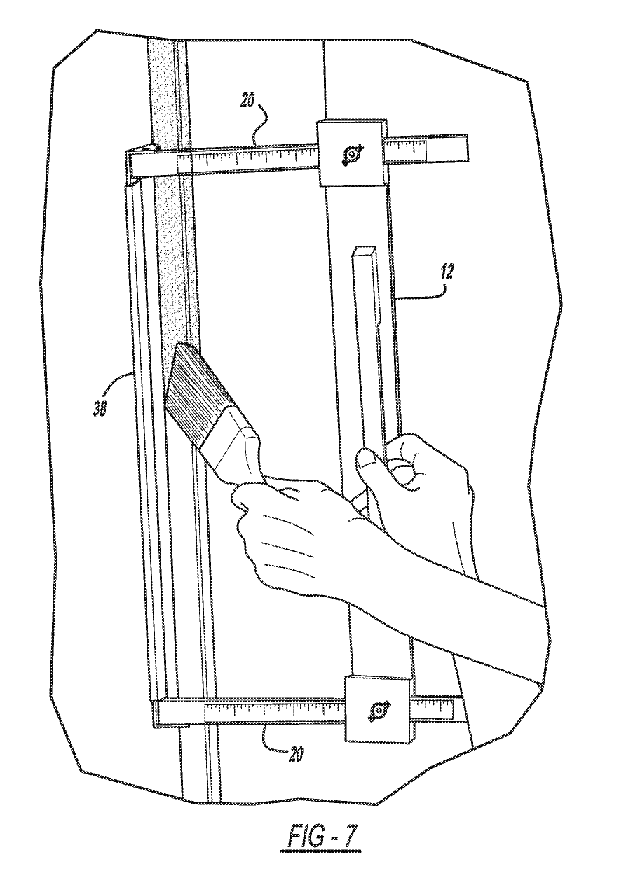

To enable the metal guide bar 36 to be conveniently used as an edging tool while painting, it was necessary to pivot the metal guide bar 36 from its position when used as a measuring tool, since a painter's hand holding a paint brush would interfere with the cross-beam member 12. Providing a pivot point for the metal guide bar 36 was simply accomplished by lengthening the metal guide bar 36 sufficiently to wrap each end of the metal guide bar 36 around the upper surface of the column member 20 and attach the end of the metal guide bar 36 to the side surface 42 of the column members 20 as shown in FIG. 3. The metal guide bar 36 is attached to the side surface 42 of the column members 20 with a small screw 44. This attachment arrangement permits the metal guide bar 36 with the snap-on reinforcement member to be pivoted to a horizontal position when the invention is used as a sizing sealant applicator tool for a wallpaper border and in approximately 10°-25° pivoted position to the horizontal when it is desired to use the invention as an edging tool for painting as shown in FIG. 7.

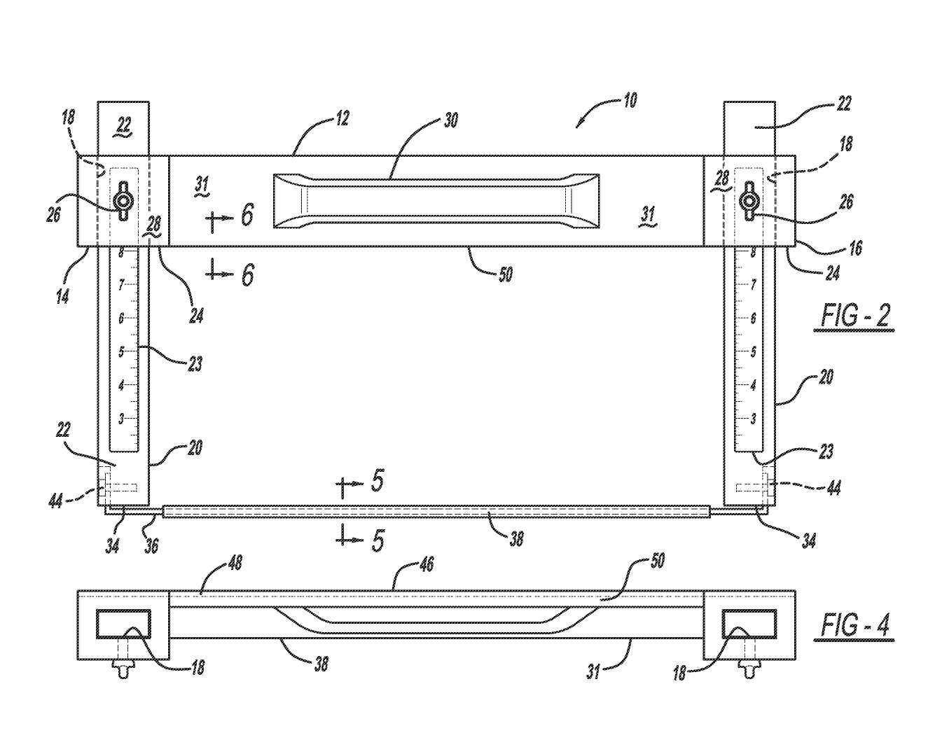

FIG. 6 is a cross-sectional view along line 6-6 of the cross-beam member 12 shown in FIG. 2 and illustrates an additional feature of the invention. As shown in FIG. 6, a metal bridge member 51 is mounted to the end face 50 of the cross-beam member 12 to provide a straight edge for setting the width of the wallpaper border. Also, on the rear face 46 of the cross-beam member 12 is an undercut surface 48 near the end face 50. A resilient material 52 is mounted within the undercut surface 48 across the complete width of the cross-beam member 12. The resilient material 52 will collect any sealant draining down the wall within the wallpaper border area and avoid overflow sealant from traveling down the wall onto freshly applied wallpaper or freshly painted wall surface.

In using the wallpaper border sizing sealant applicator apparatus 10 of the invention, the wallpaper border width is set by loosening the two wing screws 26 so that the cross-beam member 12 can be moved along the column members 20 to set the width of the wallpaper border to be applied to the wall by sliding the cross-beam member 12 to the comparable width on the metal rulers 23 mounted to the column members 20. The wing screws 26 are then tightened to lock the slide blocks 14, 16 to the column members 20. For applying a wallpaper border at the top of a wall near the ceiling, a user grasps the finger grip bar 30 and while standing on a chair or ladder, places the wallpaper border sizing sealant applicator apparatus 10 flat against the wall with the metal guide bar 36 resting against the ceiling. Note that by turning FIG. 1 180°, a ceiling border application is illustrated. The area of the wall between the metal guide bar 36 and the end face 50 of the cross-beam member 12 is then wetted with sizing sealant using a paint brush. If excess sealer runs down the wall, it will be absorbed by the resilient material 52 located in the undercut surface 48 of the rear face 46 of the cross-beam member 12. The ladder or chair used to stand on can then be repositioned and the remainder of the sizing sealant can be applied to the wall so that thereafter the wallpaper border may be applied to the sealant area without soiling the wallpaper already applied to the walls.

While the present invention has been described in terms of a preferred embodiment, it is apparent that other forms may be adopted by one skilled in the art. In other words, claim elements are not limited to the imperfection of the exact language used, but encompass as well other structures that fulfill the same functional purpose. Those skilled in the art will appreciate that other applications are possible with this invention. Accordingly, the present invention is not limited to the preferred embodiment disclosed. Therefore, the scope of the present invention is to be limited only by the following claims.

What is claimed is:

1. A wallpaper border sealant applicator apparatus comprising:
a longitudinal cross-beam member having:
one end defining a first slide block member;
an opposite end defining a second slide block member;
a front face; and
an oppositely disposed rear face,
each of said first and second slide block members having a through opening therein;
a pair of column members, one each of said pair of column members mounted in said through opening of a respective one of said first and second slide block member for sliding engagement therewith, each of said pair of column members having a front face;
straight edge means pivotably mounted to one end of said pair of column members;
measurement indicia displayed on said front face of each of said pair of column members;
a handle mounted to said cross-beam member interposed said first slide block and said second slide block member; and
locking apparatus mounted to each said first and second slide block members for allowing sliding movement between said cross-beam member and said pair of column members when said locking apparatus is in the unlocked position and for preventing movement of said cross-beam member with respect to said pair of column members when said locking apparatus is in a locked position.

2. The wallpaper border sealant applicator apparatus as claimed in claim 1 wherein said straight edge means further comprises:
a guide bar member having:
one end pivotally attached to one of said pair of column members;
an opposite end pivotally attached to the other of said column member; and
means for fastening said guide bar member for pivotable movement of said guide bar member with respect to said pair of column members.

3. The wallpaper border sealant applicator apparatus as claimed in claim 2 wherein said straight edge means further comprises a reinforcement member mounted to said guide bar member for movement therewith.

4. The wallpaper border sealant applicator apparatus as claimed in claim 1 further comprises:
a ruler mounted on said front face of each of said pair of column members; and
wherein said measurement indicia is displayed on said ruler.

5. The wallpaper border sealant applicator apparatus as claimed in claim 1 wherein said locking apparatus further comprises a wing screw member mounted in said through opening of each said first and second slide block members, each said wing screw member locking each respective slide block member to a respective one of said pair of column members such that said cross-beam member is slidably adjustable on said pair of column members to set the width of the wallpaper border and said cross-beam member is locked to said pair of column members at said width such that adhesive sealant may be applied to a wall.

6. The wallpaper border sealant applicator apparatus as claimed in claim 1 wherein said cross-beam member, first and second slide block members, and handle are formed as a unified, integrated structure.

7. The wallpaper border sealant applicator apparatus as claimed in claim 1 wherein said cross-beam member further comprises an end face, and further wherein said rear face of said cross-beam member has an undercut therein.

8. The wallpaper border sealant applicator apparatus as claimed in claim 7 further comprising an absorptive member mounted in said undercut in said rear face of said cross-beam member.

9. The wallpaper border sealant applicator apparatus as claimed in claim 7 further comprising a bridge member mounted to said end face of said cross-beam member.

10. A wallpaper border sealant applicator apparatus comprising:
a longitudinal cross-beam member having:
one end defining a first slide block member;
an opposite end defining a second slide block member;
a front face;
an oppositely disposed rear face having an undercut therein; and
an end face spanning between said front and opposite rear face;
each of said first and second slide block members having a through opening therein;
a pair of column members, one each of said pair of column members mounted in said through opening of a respective one of said first and second slide block member for sliding engagement therewith, each of said pair of column members having a front face;
a guide bar member having:
one end pivotally attached to one of said pair of column members;
an opposite end pivotally attached to the other of said pair of column members; and
means for fastening said guide bar member for pivotable movement of said guide bar member with respect to said pair of column members;
a ruler mounted on said front face of each of said pair of column members;
measurement indicia displayed on the front face of said ruler;
a wing screw member mounted in said through opening of each of said first and second slide block members, each said wing screw member locking each respective slide block member to a respective one of said pair of column members such that said cross-beam member is slidably adjustable on said pair of column members to set the width of said wallpaper border and said cross-beam member is locked to said pair of column members at said width such that an adhesive sealant may be applied to the wall;
an absorptive member mounted in said undercut of said rear face of said cross-beam member; and
a bridge member mounted to said end face of said cross-beam member.

11. The wallpaper border sealant applicator apparatus as claimed in claim 10 further comprising a reinforcement member mounted to said guide bar member for movement therewith.
